(19) United States
(12) Patent Application Publication
(10) Pub. No.: US 2012/0288088 A1
(43) Pub. Date: Nov. 15, 2012

(54) METHOD AND SYSTEM FOR COMPRESSING AND ENCRYPTING DATA

(75) Inventors: Xiao Tao Chang, Beijing (CN); Yi Ge, Beijing (CN); Chun Liang Gu, Beijing (CN); Kun Wang, Beijing (CN); Qiong Zou, Beijing (CN)

(73) Assignee: INTERNATIONAL BUSINESS MACHINES CORPORATION, Armonk, NY (US)

(21) Appl. No.: 13/469,396

(22) Filed: May 11, 2012

(30) Foreign Application Priority Data
May 12, 2011 (CN) 2011 101022963.5

(51) Int. Cl. G06F 21/24

(52) U.S. Cl. 380/28

(57) ABSTRACT

A method and system for compressing and encrypting data. The method includes: receiving original data; performing a first compression of the original data to obtain a first compression result; and encrypting only a literal portion in the first compression result to obtain an encrypted first compression result. Various embodiments improve the efficiency of the process of compression and encryption to a great extent by encrypting only the literal portion of the compression result.

### TECHNICAL FIELD

The invention generally relates to the technical field of information processing and, particularly, to a method and system for compressing and encrypting data.

### BACKGROUND ART

Now, a large number of information data are transmitted at information nodes. For a virtual private network (abbreviated to VPN), when persons have access to an internal resource at their working place over the Internet from the outside, it is usually required to compress and encrypt data, such that a data flow quantity can be decreased, a network rate can be increased, and a network congestion can be reduced by means of compression, and a security can be enhanced, and a leakage of working data and personal data can be avoided by means of encryption. For another example, in a cloud storage environment, since a storage device for the cloud storage is usually used by many persons, it is necessary for the data to be encrypted. In order to reduce the data flow quantity, before the data are stored on a network storage server, a user may first compress then encrypt the data such that the security is improved while an occupied magnetic disk space is reduced. Additionally, a general network transmission with a security requirement and a certain bandwidth requirement also demands the compression and encryption. That is to say, an application scenario of data compression to reduce the data flow quantity and data encryption to ensure the privacy thereof at the same time is very wide.

FIG. 1 shows a conventional algorithm for performing a compression and an encryption at the same time, wherein at the compression stage, original data are first compressed (for example, using a Deflate algorithm) to generate compressed data, and then the new data are encrypted (for example, using an AES block encryption algorithm) to finally generate final data which are compressed and encrypted. Herein, a general text compression algorithm, for example, the Deflate algorithm, comprises two steps, which are the sliding window dictionary coding compression algorithm, such as LZ77, and the Huffman coding compression algorithm, respectively. The LZ77 performs the compression by using data repeat, that is, to generate literals and <length, distance> tuples, in which two components of the tuples are an address and a length. The Huffman coding utilizes different occurrence frequency of the data to perform the compression coding. The LZ77 algorithm and the Huffman coding are both the compression algorithm widely used in the industry, thus they are not described in detail here to shorten the length.

Current compression and encryption algorithms have defects of a long time of compression and encryption, and a low efficiency.

Therefore, there is a need for a method and system for compressing and encrypting data with a higher efficiency.

### SUMMARY OF THE INVENTION

In one aspect, the present invention provides a method for compressing and encrypting data, comprising: receiving original data; performing a first compression of said original data to obtain a first compression result; and encrypting only a literal portion in the first compression result to obtain an encrypted first compression result.

In another aspect, the present invention provides a system for compressing and encrypting data, comprising: a receiving means configured to receive original data; a first compressing means configured to perform a first compression of said original data to obtain a first compression result; and an encrypting means configured to encrypt only a literal portion in the first compression result to obtain an encrypted first compression result.

Embodiments of the present invention improve the efficiency of the process of compression+encryption to a great extent by means of encrypting only the literal portion of the compression result.

### BRIEF DESCRIPTION OF THE DRAWINGS

In order to explain features and advantages of the present invention in detail, we will make reference to the following drawings. If possible, the same or similar reference numbers are used in the drawings and the description to denote the same or similar parts, wherein:

FIG. 1 shows an existing method for compressing and encrypting data;

FIG. 2 shows a proportion of time consumed by the encryption in an existing compression and encryption technique;

FIG. 3 shows a first embodiment of a method for compressing and encrypting data of the present invention;

FIG. 4 shows a second embodiment of a method for compressing and encrypting data of the present invention;

FIG. 5 shows a specific application example of the present invention;

FIG. 6 shows an effect when a related embodiment of the present invention is applied;

FIG. 7 shows a structural schematic diagram of a system for compressing and encrypting data of the present invention;

FIG. 8 schematically shows a structural block diagram of a computing device which may implement an embodiment according to the present invention.

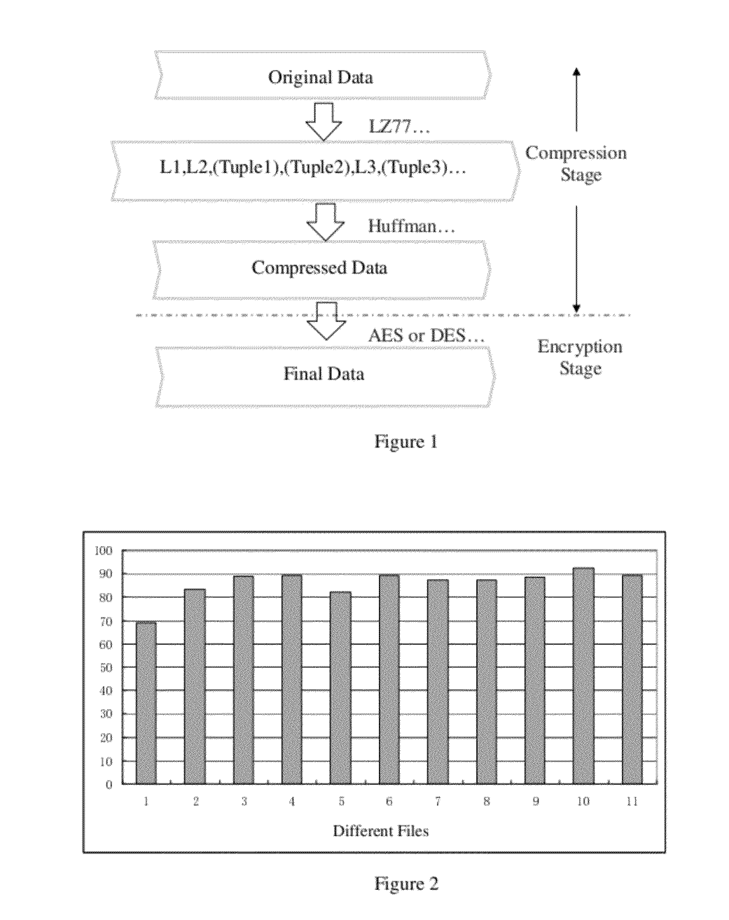

### DETAILED DESCRIPTION OF THE PREFERRED EMBODIMENTS

Now the description will be made in detail with reference to exemplary embodiments of the present invention. Examples of said embodiments are illustrated in the appended drawings, throughout which the like reference numbers denote the like elements. It should be understood that the present invention is not limited to the disclosed exemplary embodiments. It should also be understood that not every feature of said method and device is necessary for implementing the present invention claimed by any claim. Further, in the entire disclosure, when a process or method is shown or described, steps of the method may be performed in any order or simultaneously, unless it is apparent from the context that one step depends on another step performed previously. Further, there may be a significant time interval between steps.

When studying to solve the defects of the existing compression and encryption technique, the applicant has findings as shown in FIG. 2 in which the transverse axis represents compressed and encrypted samples comprising electronic files downloaded from a network (six files from the first) and parts of web pages (four files from the last) and the longitudinal axis represents a time proportion percentage in the whole process of “compression+encryption”. In the whole process of “compression+encryption” using an exemplary RSA encryption algorithm, FIG. 2 shows that a process of encryption accounts for almost all proportion, therefore if the encryption efficiency can be improved and the encryption level is not lowered, it is obvious that the existing technique of “compression+encryption” can be effectively enhanced. Also, the time for encrypting data is positively proportional to the quantity of data, thus a whole performance of “compression+encryption” may be improved when the quantity of compressed data is reduced.

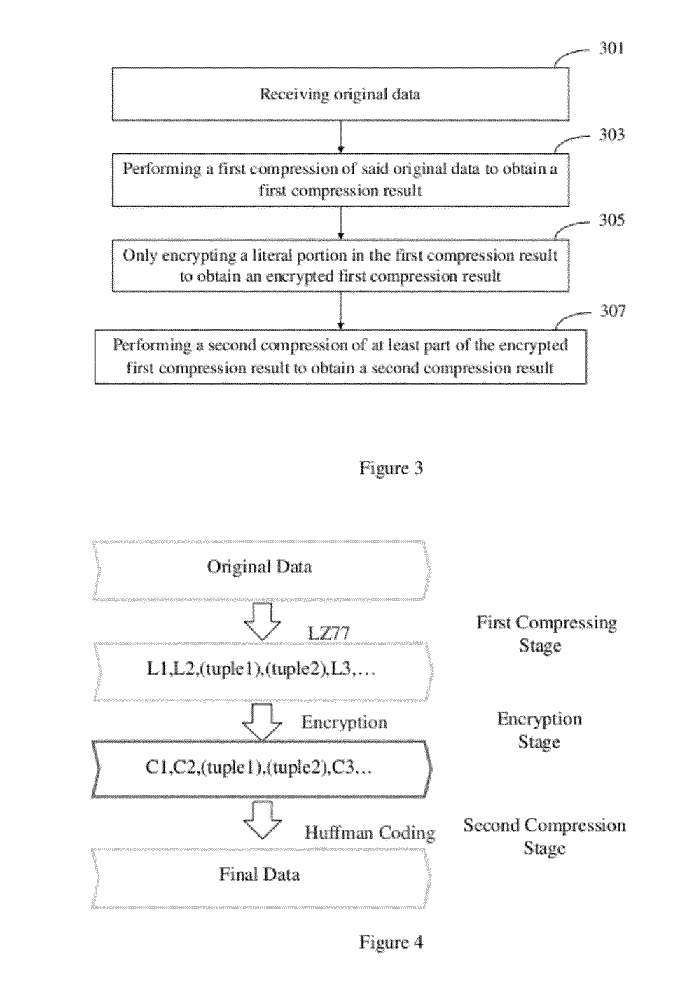

Based on the above data analysis findings, the applicant proposes a first embodiment of a method for compressing and encrypting data of the present invention, as shown in FIG. 3. At step 301, original data are received. Preferably, said original data comprise at least one of text data and binary data. At step 303, a first compression of said original data is performed to obtain a first compression result. Based on the present application, those skilled in the art may adopt any suitable compression algorithm capable of generating a literal portion, such as LZ77, LZ78, LZW and the like. The literal portion refers to a certain portion of original data that are maintained without any change until they are outputted in the process of applying the LZ77 or the similar algorithm. The literal portion is a common term for those skilled in the art. At step 305, only the literal portion in the first compression result is encrypted to obtain the encrypted first compression result. With respect to the LZ77 and the similar algorithms, whether what is generated at present is the literal portion or the other data portion (e.g., tuple) can be determined by looking up a history dictionary, and a position where the literal portion is located in the entire first compression result can be known. Of course, a text portion can be marked in the generated compressed file by means of a marking method. Based on the present application, those skilled in the art may adopt any suitable algorithm capable of encrypting the literal potion, including a flow encryption algorithm or a block encryption algorithm, for example, at least one of the RC4 flow encryption algorithm (particularly, see http://en.wikipedia.org/wiki/RC4), the AES or DES block encryption algorithm (particularly, see http://en.wikipedia.org/wiki/Advanced_Encryption_Standard and http://en.wikipedia.org/wiki/Data_Encryption_Standard), the RSA or ECC block encryption algorithm (particularly, see http://en.wikipedia.org/wiki/RSA and http://en.wikipedia.org/wiki/ECC). Preferably, the present invention may further include step 307, at which a second compression is performed to at least part of the encrypted first compression result (for instance, performing the second compression only to the compression result of the literal portion) to obtain a second compression result. Based on the present application, those skilled in the art may employ any suitable second compression algorithm capable of compressing the literal portion, for example, the Huffman coding, the Shannon-Fano coding and the like. With the above method, it can be ensured that time consumption of the encryption process is reduced to a large extent while the security level is not lowered so as to greatly improve a user experience.

FIG. 4 shows a second embodiment of a method for compressing and encrypting data of the present invention. The second embodiment includes three stages:

1. The First Compression State:

In this stage, original data comprising text data are received, and the original data are compressed by employing the LZ77 compression algorithm. After being subject to the LZ77 compression algorithm, the original data are formed to a first compression result as shown in FIG. 4. The first compression result can comprise the literal portion of L1, L2, L3 . . . etc, and the tuples of Tuple 1, Tuple 2 . . . , in which said tuple represents a distance and a length, the distance usually indicates a distance from a header of previous string data represented by the tuple to the current position, and the length indicates a length of the string represented by the tuple. Once the two are determined, the string represented by the tuple will be determined Table 1 shows proportions of the byte numbers of the literal portions to the compression results after undergoing the LZ77 compression in various original data source, and the proportion is about 30% in general.

TABLE 1

| | Proportion of the literal portion |
|---|---|
| Original data source | to the compression result (%) |
| www.sina.com.cn | 29.6 |
| www.sohu.com | 35.9 |

2. The Encryption State:

In this stage, any existing suitable text encryption algorithm is used to encrypt only the literal portions of L1, L2, L3 . . . . Since the distance and the length in the tuple do not contain information on the original text, and restoration of the original file depends on the literal portion, encrypting only the literal portion can not lower the encryption level. After undergoing the first compression and the encryption, the original data are changed into C1, C2, (tuple1), (tuple2), C3 . . . , wherein C1, C2, C3 . . . are the compression results corresponding to the literal portions of L1, L2, L3 . . . , respectively. As only the literal portions amounting for about 30% are encrypted and the rest tuples portions amounting for nearly 70% are not encrypted at the encryption stage, the present embodiment saves about 70% of the encryption time, thus the encryption efficiency is increased to a large extent.

When a specific encryption algorithm is performed, if a flow encryption algorithm, for example the RC4, is adopted, it will be directly applied to the embodiment. If a block encryption algorithm, for example the AES/DES, or the RSA/ECC, is adopted, it is required that the original data are inputted in a block format, that is, the unit of data encryption must be a fixed length (except for a last block of the entire file to be encrypted), such as 16 bytes, 32 bytes and the like. Therefore, in the method, since the literal portion is generated discretely, with respect to the block encryption method, a source block buffer is used to buffer the literal portion in said first compression result, and a target block buffer is used to buffer the encryption result of said literal portion. When the source block buffer is full, the encryption can be performed, and the encryption result is written in the target block buffer, otherwise it is required to wait until subsequent text data arrive. Physically, the source block buffer and the target block buffer may share one buffer. With respect to the flow encryption algorithm, each byte thereof may be encrypted immediately after the literal data are generated, and outputted to the position of the literal data in the first compression result. With respect to the block encryption algorithm, the literal data are buffered in a source data buffer when being generated, and when a content of the buffer reaches a size of the block required by the encryption algorithm, for example, 32 bytes, the block is encrypted to generate new encrypted data having a size of 32 bytes, each of which is outputted to the position of the literal data in the first compression result simultaneously.

3. The Second Compression State (Optional):

On the basis of the encrypted data obtained at the encryption stage, a second compression of at least part of the encrypted data is performed by using the Huffman coding to obtain final data for transmission, such that the quantity of the original data is further reduced. Undergoing the foresaid process of compression+encryption+at least part of compression, the original data can be used for a security transmission, and the flow quantity of data to be transmitted is decreased to a great extent.

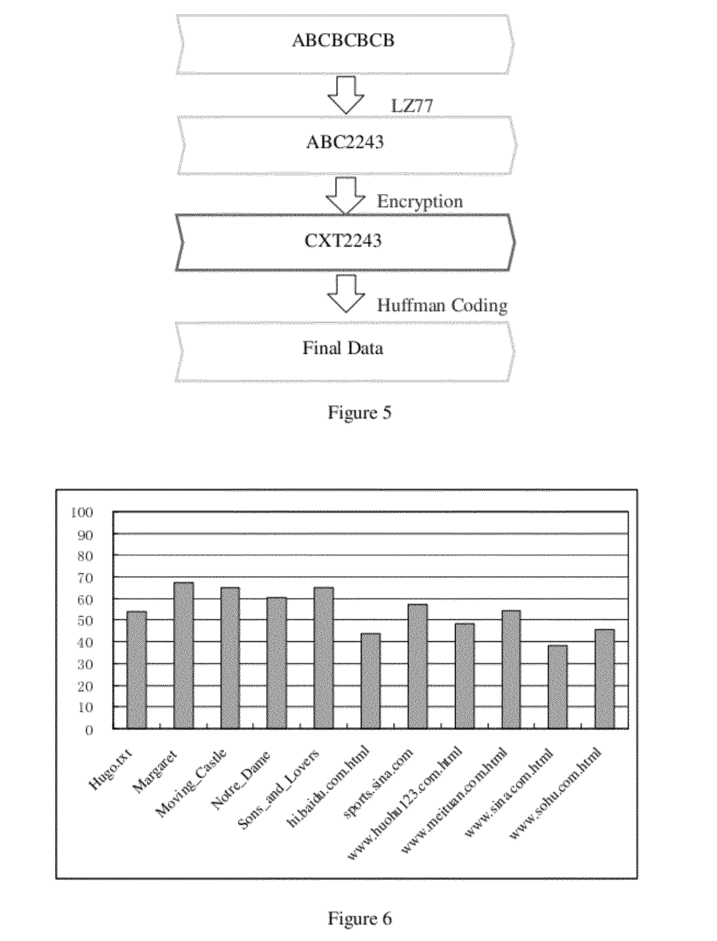

FIG. 5 shows an example of a specific application of the present invention. Assumed that the original data are a character string ABCBCBCB, after being subject to the LZ77 compression process, the ABC will serve as the literal portion and remain without change, and the BCBCB will be changed into two tuples, i.e., (22) and (43). The first element 2 of the (22) indicates forward counting two characters from the current position, i.e. the second character of the entire character string, and the second element 2 indicates the length of the characters replaced by the tuple, thus the (22) represents the BC. The first element 4 of the (43) indicates forward counting four characters from the current position, i.e., the second character of the entire character string, and the second element 3 indicates the length of the characters replaced by the tuple, thus the (43) represents the BCB. After being encrypted, the literal portion ABC is changed into CXT. Because no encryption of the tuples (22) and (43) is made, they remain unchanged, and then are performed a Huffman coding. If a receiving part does not perform a decryption (since no key can be obtained) after it performs a Huffman decoding on the final data, but directly performs a reverse process of the LZ77, the obtained data will be CXTCXCXT, rather than the original ABCBCBCB. It can be seen that the present application example does not lower the security level while increasing the efficiency.

FIG. 6 shows an effect when a related embodiment of the present invention is applied, in which the adopted original data samples are electronic files downloaded from a network (six files from the first) and parts of web pages (four files from the last), the first compression algorithm employs the LZ77 algorithm, the encryption algorithm employs the RSA encryption algorithm, and finally the Huffman coding is used to perform the second compression. In FIG. 6, transverse axis represents the original data samples, and longitudinal axis represents optimized percentage, and it can be explicitly seen from FIG. 6 that the time efficiencies for these samples are differently increased by about 35%-65%, respectively.

The invention is adapted to be applied in various application scenarios necessary for the compression+encryption, such as a cloud storage, the VPN, and so forth.

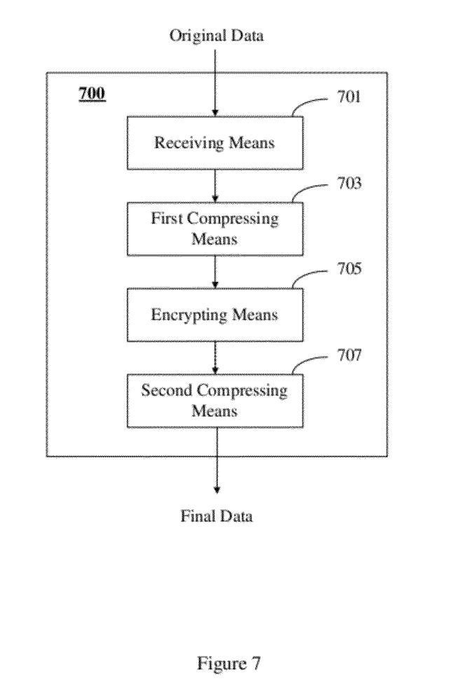

As shown in FIG. 7, the invention also provides a system 700 for compressing and encrypting data. The system includes: a receiving means 701 configured to receive original data; a first compressing means 703 configured to perform a first compression of said original data to obtain a first compression result; and an encrypting means 705 configured to encrypt only a literal portion of the first compression result to obtain a encrypted first compression result.

Preferably, a second compressing means 707 is further included and configured to perform a second compression of at least part of the encrypted first compression result to obtain a second compression result.

Preferably, the first compression employs a LZ77 compression algorithm. Preferably, in the case of employing a block encryption algorithm, a source block buffer is further included and configured to buffer the literal portion in said first compression result, and a target block buffer is included and configured to buffer the encryption result of said literal portion.

Preferably, the algorithm employed by said encryption includes at least one of an RC4 flow encryption algorithm, an AES block encryption algorithm, and an RSA block encryption algorithm.

Preferably, said literal portion is at least one of text data and binary data.

Preferably, the system is applied in at least one of a cloud storage or a virtual private network.

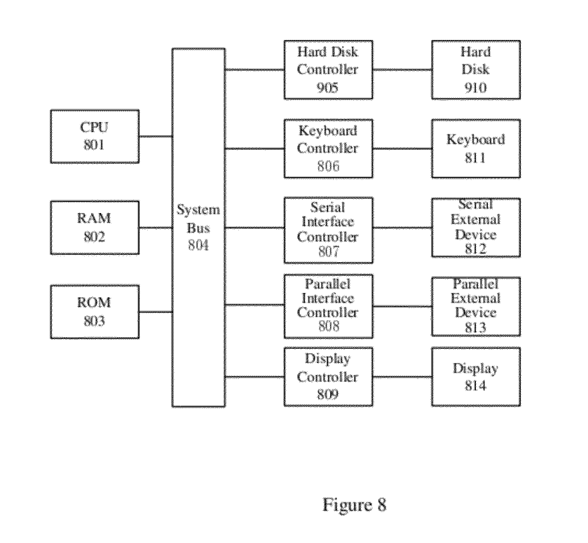

FIG. 8 schematically shows a structural block diagram of a computing device which can implement an embodiment according to the present invention. A computer system shown in FIG. 8 comprises a CPU (Center Processing Unit) 801, a RAM (Random Access Memory) 802, a ROM (Read-Only Memory) 803, a system bus 804, a hard disk controller 805, a keyboard controller 806, a serial interface controller 807, a parallel interface controller 808, a display controller 809, a hard disk 810, a keyboard 811, a serial external device 812, a parallel external device 813, and a display 814. In these components, the CPU 801, the RAM 802, the ROM 803, the hard disk controller 805, the keyboard controller 806, the serial interface controller 807, the parallel interface controller 808 and the display controller 809 are connected with the system bus 804. The hard disk 810 is connected with the hard disk controller 805, the keyboard 811 is connected with the keyboard controller 806, the serial external device 812 is connected with the serial interface controller 807, the parallel external device 813 is connected with the parallel interface controller 808, and the display 814 is connected with the display controller 809.

A function of each component in FIG. 8 is well known in the art, and the structure shown in FIG. 8 is conventional. Such structure is used not only in a personal computer, but also in a hand-held device such as a Palm PC, a PDA (Personal Digital Assistant), a mobile phone and the like. In different applications, for example, when being used to implement a user terminal comprising a client module according to the present invention or a server host comprising a network application server according to the present invention, some components may be added into the structure shown in FIG. 8, or some components in FIG. 8 may be omitted. Usually, the whole system shown in FIG. 8 is controlled by computer readable instructions as software stored in the hard disk 810, or an EPROM, or other non-volatile memory. The software may also be downloaded from a network (not shown in the Figure), or stored in the hard disk 810, or the software downloaded from the network may be loaded into the RAM 802, and executed by the CPU 801 so as to accomplish a function determined by the software.

Although the computer system illustrated in FIG. 8 can support a technical solution proposed according to the present invention, the computer system is just an example of computer systems. Those skilled in the art can understand that many other designs of a computer system can also implement embodiments of the present invention.

Herein, while the exemplary embodiments of the present invention are described with reference to the appended drawings, it should be understood that the present invention is not limited to these accurate embodiments, and those skilled in the art can make a variety of changes and modifications to the embodiments without departing from the scope and spirit of the present invention. All these changes and modifications are intended to be included within the scope of the present invention defined by the appended claims.

According to above description, those skilled in the art know the present invention may be embodied as an apparatus, method or computer program product. Accordingly, the present invention may be embodied in following forms, that is, may be an entire hardware, an entire software (including firmware, resident software, microcode, etc.), or a combination of a software component and a hardware component, which are generally referred to herein as “circuit”, “module” or “system”. In addition, the present invention may also take the form of a computer program product embodied in any tangible medium of expression having a computer usable program code in the medium.

Any combination of one or more computer-usable or computer-readable medium(s) can be used. The computer-usable or computer-readable medium may be, for example, but not limited to, an electronic, magnetic, optical, electromagnetic, infrared or semiconductor system, apparatus, device or propagation medium. More specific examples (a non-exhaustive list) of the computer-readable medium include the following: an electrical connection with one or more wires, a portable computer disk, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, electrical scanning of the paper or other medium, then compiled, interpreted, or processed in a suitable manner, and stored in a computer memory if necessary. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embedded therewith, either in baseband or as part of a carrier wave. The computer-usable program code may be transmitted using any suitable medium, including, but not limited to, wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on a user's computer, as a stand-alone software package, partly on a user's computer and partly on a remote computer or entirely on a remote computer or server. In the latter scenario, the remote computer may be connected to the user's computer through any type of network, including a local area network (LAN), or a wide area network (WAN), or the connection may be made to an external computer (for example, through the Internet using an Internet Service Provider).

Further, in the present invention, each block of the flowcharts and/or block diagrams and combinations of blocks in the flowcharts and/or block diagrams, can be both performed by computer program instructions. These computer program instructions may be provided to a processor of a general purpose computer, special purpose computer, or other programmable data processing apparatus, thereby producing a machine, such that the instructions, which execute by the computer or the other programmable data processing apparatus, create means for performing the functions/operations specified in the block or blocks in the flowcharts and/or block diagrams.

These computer program instructions may also be stored in a computer-readable medium that can direct a computer or other programmable data processing apparatus to function in a particular manner, such that the instructions stored in the computer-readable medium produce an article of manufacture including instruction means performing the functions/operations specified in the block or blocks in the flowcharts and/or block diagrams.

The computer program instructions may also be loaded onto a computer or other programmable data processing apparatus to cause a series of operation steps to be performed on the computer or other programmable data processing apparatus to generate a computer performed process such that the instructions which execute on the computer or other programmable data processing apparatus provide processes for performing the functions/operations specified in the block or blocks in the flowcharts and/or block diagrams.

The flowcharts and block diagrams in the drawings illustrate the architecture, functionality and operation of possible implementations of systems, methods and computer program products according to various embodiments of the present invention. In this regard, each block in the flowcharts or block diagrams may represent a modular, program segment, or part of code, which comprises one or more executable instructions for performing the specified logic function(s). It should also be noted that, in some alternative implementations, the functions noted in the block may also occur in an order other than that noted in the drawings. For example, two blocks consecutively shown may, in fact, be performed substantially in parallel, or sometimes they may be performed in a reverse order, depending upon the functionality involved. It will also be noted that, each block of the block diagrams and/or flowcharts and combinations of blocks in the block diagrams and/or flowcharts, can be performed by using a special purpose hardware-based system that executes the specified functions or operations, or by using a combination of a special purpose hardware and computer instructions.

1. A method for compressing and encrypting data, comprising:
receiving original data;
performing a first compression of said original data to obtain a first compression result; and
encrypting only a literal portion in the first compression result to obtain an encrypted first compression result.

2. The method according to claim 1, further comprising:
performing a second compression of at least part of the encrypted first compression result to obtain a second compression result.

3. The method according to claim 1, wherein the first compression employs a LZ77 compression algorithm.

4. The method according to claim 1, wherein if a block encryption algorithm is employed, a source block buffer is used to buffer the literal portion of said first compression result, and a target block buffer is used to buffer the encrypted result of said literal portion.

5. The method according to claim 1, wherein an algorithm employed by said encryption comprises at least one of a RC4 flow encryption algorithm, an AES block encryption algorithm and a RSA block encryption algorithm.

6. The method according to claim 1, wherein said literal portion is at least one of text data and binary data.

7. The method according to claim 1, wherein said method is used in at least one of a cloud storage or a virtual private network.

8.-14. (canceled)

15. The computer program product for compressing and encrypting data, the computer program product comprising a tangible storage medium readable by a processing circuit and storing instructions run by the processing circuit for performing a method, the method comprising:
receiving original data;
performing a first compression of said original data to obtain a first compression result; and
encrypting only a literal portion in the first compression result to obtain an encrypted first compression result.

16. The computer program product according to claim 15, wherein the method further comprises:
performing a second compression of at least part of the encrypted first compression result to obtain a second compression result.

17. The computer program product according to claim 15, wherein the first compression employs a LZ77 compression algorithm.

18. The computer program product according to claim 15, wherein if a block encryption algorithm is employed, a source block buffer is used to buffer the literal portion of said first compression result, and a target block buffer is used to buffer the encrypted result of said literal portion.

19. The computer program product according to claim 15, wherein an algorithm employed by said encryption comprises at least one of a RC4 flow encryption algorithm, an AES block encryption algorithm and a RSA block encryption algorithm.

20. The computer program product according to claim 15, wherein said literal portion is at least one of text data and binary data.
